(19) United States
(12) Patent Application Publication
(10) Pub. No.: US 2025/0198545 A1
(43) Pub. Date: Jun. 19, 2025

(54) CIRCULATION PIPE STRUCTURE AND MANUFACTURING METHOD THEREOF

(71) Applicants: HYUNDAI MOTOR COMPANY, Seoul (KR); KIA CORPORATION, Seoul (KR)

(72) Inventors: Min Gyun Chung, Seoul (KR); Hyeong Won Park, Hwaseong-si (KR)

(73) Assignees: HYUNDAI MOTOR COMPANY, Seoul (KR); KIA CORPORATION, Seoul (KR)

(21) Appl. No.: 18/632,610

(22) Filed: Apr. 11, 2024

(30) Foreign Application Priority Data
Dec. 19, 2023 (KR) 10-2023-0185662

(51) Int. Cl. F16L 9/22; B29C 45/00; B29K 77/00; B29K 309/08; B29L 23/00; F16L 9/128

(52) U.S. Cl. CPC F16L 9/22; B29C 45/0062; F16L 9/128; B29C 2045/0063; B29K 2077/00; B29K 2309/08; B29L 2023/22

(57) ABSTRACT

A circulation pipe structure and a manufacturing method thereof are provided. The circulation pipe structure includes an upper member, a lower member coupled to the upper member to form the circulation pipe structure, and first coupling parts respectively provided on the upper member and the lower member. The first coupling parts are engaged with each other when the upper member and the lower member are coupled. The circulation pie structure also includes a second coupling part that couples the upper member and the lower member to each other by a coupling member.

### CROSS-REFERENCE TO RELATED APPLICATION

This application claims under 35 U.S.C. § 119 (a) the benefit of priority to Korean Patent Application No. 10-2023-0185662 filed on Dec. 19, 2023, the entire contents of which are incorporated herein by reference.

### BACKGROUND

### (a) Technical Field

The present disclosure relates to a circulation pipe structure and a manufacturing method thereof.

### (b) Background Art

A drive motor is a key part of an electric vehicle together with a battery pack. Additionally, various technologies are applied in an electric vehicle to improve the output of the vehicle, extend the range of the vehicle, and achieve low noise and lightweight. Treatment of generated heat is very important in the drive motor mounted on electric vehicles. Since high-temperature heat is generated in certain situations, such as uphill driving or high-speed driving, it is necessary to effectively remove the generated heat. Thus, various types of cooling devices are desired.

As cooling channels and circulation pipes through which cooling fluid for cooling the drive motor may flow, cooling pipes formed of stainless steel are mainly applied. In this case, sufficient insulation distances from peripheral units using high-voltage components should be secured. Thus, there are drawbacks, such as restrictions on a layout and disadvantages in terms of weight reduction and cost reduction.

Therefore, a circulation pipe that minimizes restrictions on a layout design and ensures weight reduction and cost reduction is desired.

The above information disclosed in this Background section is only to enhance understanding of the background of the disclosure. Therefore, the Background section may contain information that does not form the prior art that is already known in this country to a person having ordinary skill in the art.

### SUMMARY

The present disclosure has been made to solve the above-described problems associated with the prior art. It is an object of the present disclosure to provide a circulation pipe structure for cooling a drive motor, which does not require securing an insulation distance, thus allowing for unrestricted layout, and offering a high degree of freedom in design.

It is another object of the present disclosure to provide a circulation pipe structure that includes a polymer-based material as a cooling pipe for drive motors to ensure economic efficiency and formability.

The objects of the present disclosure are not limited to the above-mentioned objects. The objects of the present disclosure should become apparent from the following description and may be realized by means stated in the claims and combinations thereof.

In one aspect, the present disclosure provides a circulation pipe structure including an upper member, a lower member coupled to the upper member to form the circulation pipe structure, and first coupling parts respectively provided on the upper member and the lower member engaged with each other when the upper member and the lower member are coupled. Additionally, the circulation pipe structure includes a second coupling part that couples the upper member and the lower member to each other by a coupling member.

In another aspect, the present disclosure provides a manufacturing method of a circulation pipe structure. The manufacturing method includes primarily injecting a first polymer material simultaneously into a first mold having a shape of an upper member and a second mold having a shape of a lower member. The manufacturing method also includes engaging the upper member and the lower member with each other while forming gaps therebetween by moving one of the first mold and the second mold. The manufacturing method also includes secondarily injecting a second polymer material into the gaps. In primarily injecting the first polymer material into the first mold and the second mold, the first mold and the second mold are spaced apart from each other. In secondarily injecting the second polymer material into the gaps, a temperature of the upper member and the lower member is 140° C. or higher, and an injection temperature of the second polymer material is 300° C. or higher.

Other aspects and embodiments of the present disclosure are discussed below.

The above and other features of the disclosure are discussed below.

### BRIEF DESCRIPTION OF THE DRAWINGS

The above and other features of the present disclosure are described in detail with reference to certain embodiments thereof illustrated in the accompanying drawings which are given hereinbelow by way of illustration only, and thus are not limitative of the present disclosure, and wherein:

FIG. 1A is a schematic view showing an area where a circulation pipe structure according to one embodiment of the present disclosure is applied;

FIG. 1B is a schematic view showing circulation of cooling oil;

FIG. 2 is a perspective view showing members of a circulation pipe structure according to one embodiment of the present disclosure;

FIG. 3 is an enlarged schematic view showing a cross-section of a coupling part of a circulation pipe structure according to one embodiment of the present disclosure;

FIGS. 4A-4C are schematic views showing various embodiments of a cross-section of a coupling part of a circulation pipe structure according to the present disclosure;

FIG. 5 is a schematic view showing a manufacturing method of a circulation pipe structure according to one embodiment of the present disclosure;

FIG. 6 is a flowchart describing a manufacturing method of a circulation pipe structure according to one embodiment of the present disclosure;

FIGS. 7A-7D are schematic views showing various embodiments of a cross-section of a circulation pipe structure according to the present disclosure;

FIG. 8 is a photograph showing an example of a circulation pipe structure manufactured according to the present disclosure;

FIG. 9 is a schematic view showing amounts of deformation of respective parts of a circulation pipe structure in a 32 bar burst pressure test according to the present disclosure;

FIG. 10 is a computed tomography (CT) photograph of a cross-section of a part of a circulation pipe structure according to one embodiment of the present disclosure and including an injection hole;

FIG. 11 is a computed tomography (CT) photograph of a cross-section of a part of a circulation pipe structure according to one embodiment of the present disclosure without an injection hole; and

FIG. 12 is an enlarged schematic view showing a cross-section of another coupling part of a circulation pipe structure according to one embodiment of the present disclosure.

It should be understood that the appended drawings are not necessarily drawn to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages, and features of the present disclosure should become apparent from the descriptions of the embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those having ordinary skill in the art.

In the drawings, the same or similar elements are denoted by the same reference numerals even though they are depicted in different drawings. In the accompanying drawings, the dimensions of structures may be exaggerated compared to the actual dimensions thereof, for clarity of description. In the following description of the embodiments, terms, such as “first” and “second,” may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including,” “comprising,” and “having” are to be interpreted as indicating the presence of characteristics, numbers, steps, operations, elements, or parts stated in the description or combinations thereof. Such terms do not exclude the presence of one or more other characteristics, numbers, steps, operations, elements, parts, or combinations thereof, or possibility of adding the same. In addition, it should be understood that, when a part, such as a layer, a film, a region, or a plate, is said to be “on” another part, the part may be located “directly on” the other part or other parts may be interposed between the two parts. In the same manner, it should be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected. Thus, it should be understood that they are modified by the term “about,” unless stated otherwise. In addition, it should be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function.

### Circulation Pipe Structure

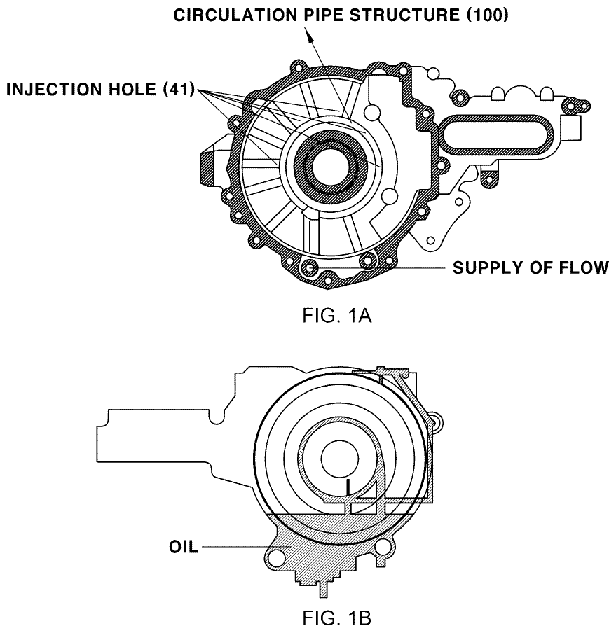

Referring to FIGS. 1-4, 7, and 12, a circulation pipe structure 100 according to one embodiment of the present disclosure may include an upper member 10 and a lower member 20. The lower member 10 may be coupled to the upper member 10 to form the circulation pipe structure 100. The circulation pipe structure 100 may also include first coupling parts 32 respectively provided on the upper member 10 and the lower member 20 so as to be engaged with each other when the upper member 10 and the lower member 20 are coupled. Additionally, the circulation pipe structure 100 may include a second coupling part 37 that couples the upper member 10 and the lower member 20 to each other by a coupling member 35.

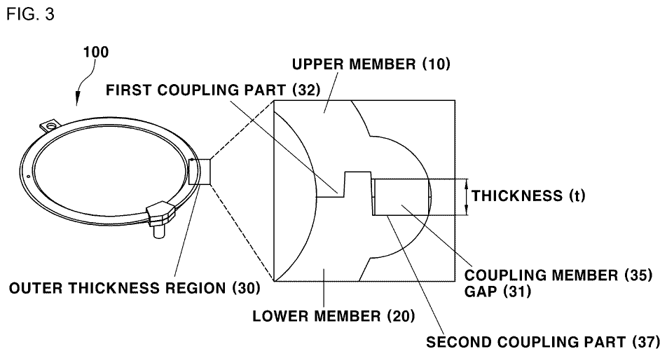

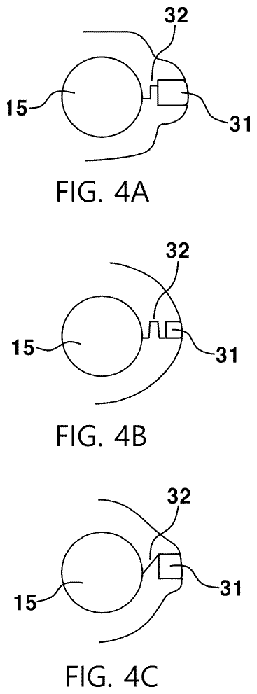

The coupling member 35 may be fused to a gap 31 between the upper member 10 and the lower member 20. The gap 31 may have a shape that is partially recessed in a direction from the outermost part of the circulation pipe structure 100 to a pipe inner space 15, in an outer thickness region 30 of the circulation pipe structure 100, as shown in FIGS. 3 and 4. The outer thickness region 30 may correspond to a thickness region provided from the outermost part of the circulation pipe structure 100 to the pipe inner space 15.

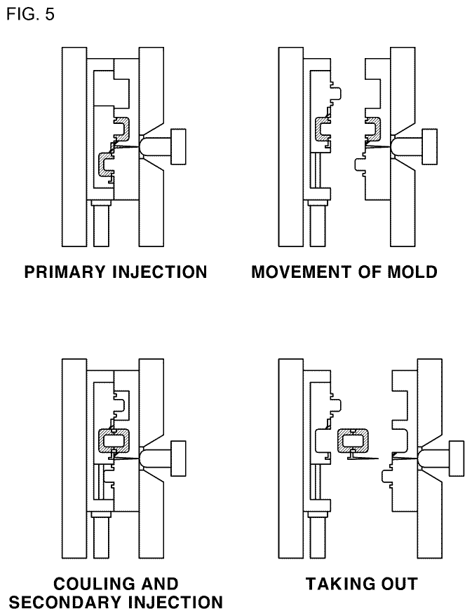

The upper member 10, the lower member 20, and the coupling member 35 may be molded and combined using die slide injection. For example, as shown in FIG. 5, the upper member 10 and the lower member 20 may be formed by primary injection molding with a first polymer material and coupled to each other to form the circulation pipe structure 100. Then the coupling member 35 may be formed by secondary injection molding with a second polymer material and fused in the gap 31 formed in the outer thickness region 30. A detailed process of manufacturing the circulation pipe structure 100 is described below.

The gap 31 may be disconnected from the pipe inner space 15 of the circulation pipe structure 100. Therefore, when the coupling member 35 is fused to the gap 31, it is possible to prevent components of the coupling member 35 from infiltrating into the pipe inner space 15.

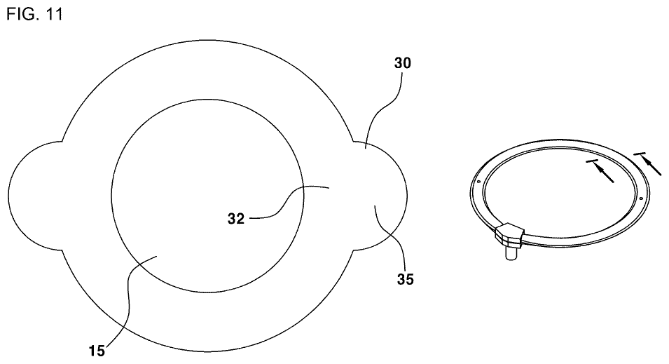

As shown in FIGS. 3 and 11, the second coupling part 37 may protrude outward from the outer thickness region 30. The second coupling part 37 may or may not protrude, may be recessed, or may have a continuous shape externally, depending on application conditions.

The first coupling parts 32 may include structures engaged with each other by an engraved-embossed part provided in and on the upper member 10 and the lower member 20 inside the coupling member 35. For example, one of the upper member 10 and the lower member 20 may include a first coupling pattern, and the other may include a second coupling pattern engaged with the first coupling pattern. The first pattern and the second pattern may include an embossed part and an engraved part, or may include wedge protrusions, wedge depressions, and the like, as shown in FIGS. 4A-4C.

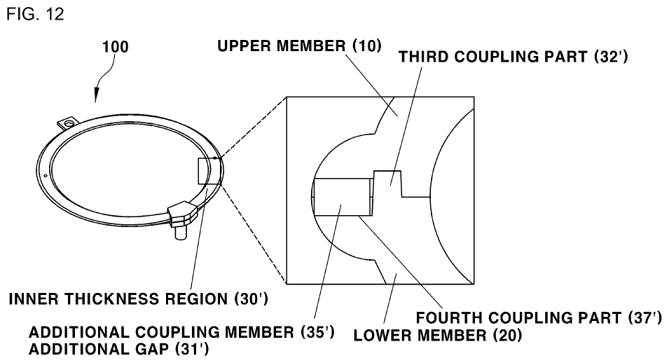

The first coupling parts 32 and the second coupling part 37 may be formed along the outer thickness region 30 of the circulation pipe structure 100. Additionally, third coupling parts 32′ and a fourth coupling part 37′ may be formed along an inner thickness region 30′ of the circulation pipe 100, as shown in FIG. 12. The inner thickness region 30′ may correspond to a thickness region provided from the innermost part of the circulation pipe structure 100 to the pipe inner space 15.

The third coupling parts 32′ may be respectively provided on the upper member 10 and the lower member 20 so as to be engaged with each other when the upper member 10 and the lower member 20 are coupled.

The fourth coupling part 37′ may couple the upper member 10 and the lower member 20 to each other by an additional coupling member 35′. The fourth coupling part 37′ may be formed by fusing the additional coupling member 35′ to an additional gap 31′ formed to have a shape that is partially recessed in an inward direction from the innermost part of the circulation pipe structure 100 to the pipe inner space 15, in the inner thickness region 30′ of the circulation pipe structure 100.

The additional gap 31′ may also be disconnected from the pipe inner space 15. The third coupling parts 32′ may include structures engaged with each other by an engraved-embossed part additionally provided in and on the upper member 10 and the lower member 20 outside the additional coupling members 35′. The shapes and thicknesses of the additional gap 31′, the additional coupling member 35′, and the additional engraved and embossed parts of the third coupling parts 32′ may be substantially the same as the gap 31, the coupling member 35, and the engraved and embossed parts of the first coupling parts 32. Additionally, the shapes and thicknesses of the additional gap 31′, the additional coupling member 35′, and the additional engraved and embossed parts of the third coupling parts 32′ may be symmetrical to the gap 31, the coupling member 35, and the engraved and embossed parts of the first coupling parts 32 with respect to the center of the pipe inner space 15.

The shape of the circulation pipe structure 100 may be a circle, an oval, a polygon, a single closed curve, or the like. In one example, the shape of the circulation pipe structure may be a circle.

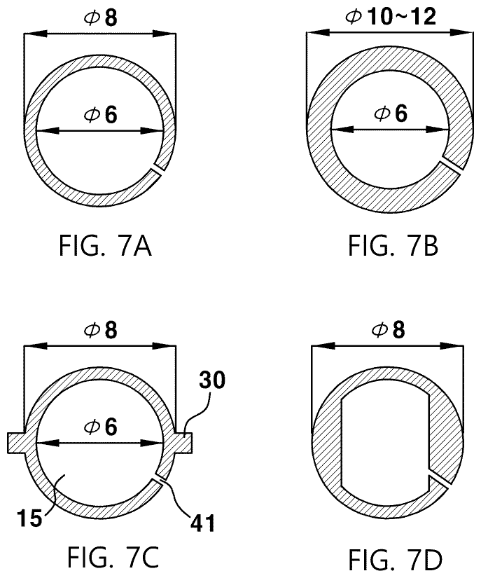

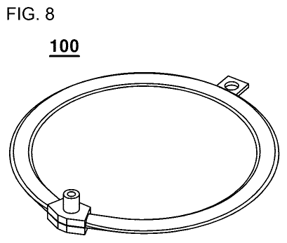

The cross-sectional shape of the pipe inner space 15, i.e., the inner circumferential cross-sectional shape, of the circulation pipe structure 100 may be a circle, an oval, a polygon, a single closed curve, or the like, and may include shapes shown in FIGS. 7A-7D. Also, FIGS. 7A-7D illustrate the values of the inner diameters and outer diameters (mm) of the circulation pipe structures according to various embodiments.

The respective inner spaces of the upper member 10 and the lower member 20 may be symmetrical to each other. Additionally, the pipe inner space 15 may be provided in a shape that facilitates the flow of cooling fluid that may be provided in the upper member 10 and the lower member 20.

The average thickness of the circulation pipe structure 100 excluding the coupling parts 35, 37, 35′ and 37′ may be in a range of 1-6 millimeters (mm), or, more specifically, in a range of 1.5-5.0 mm, based on the pipe inner space 15 and the outside of the circulation pipe structure 100.

When the second coupling part 37 of the circulation pipe structure 100 protrudes outward from the outer circumference of the circulation pipe structure 100, the protrusion length of the second coupling part 37 may be in a range of 0.5-3 times or, more specifically, in a range of 0.8-2.5 times the average thickness of the circulation pipe structure 100. By protruding the second coupling part 37 in this ratio, burst pressure-related properties required for cooling pipes of drive motors may be secured and deterioration of formability may be minimized.

In the same manner, the fourth coupling part 37′ of the circulation pipe structure 100 may protrude inwards from the inner circumference of the circulation pipe structure 100 in the same ratio.

The gap 31 may be formed by spacing a first wing provided on the outer circumference of the upper member 10 and a second wing provided on the outer circumference of the lower member 20 apart from each other.

The thickness t of the gap 31 may be in range of 0.3-2.5 mm, or more specifically, in a range of 0.5-2.0 mm, or 1-1.5 mm.

The coupling member 35 fused to the gap 31 may fill the entirety of the gap 31, and the thickness of the gap 31 and the thickness of the coupling member 35 may be substantially the same. By having this thickness range, it is possible to secure sufficient bonding strength while minimizing deformation of the upper member 10 and the lower member 20.

Polymer-based materials included in the circulation pipe structure 100 may include one selected from the group consisting of a polyamide-based resin, polycarbonate-based resin, a polystyrene-based resin, or any combinations thereof, and the polymer-based materials may further include an inorganic filler.

The upper member 10 and the lower member 20 may include substantially the same polymer-based material. In some cases, the coupling member 35 may also include the same polymer-based material.

The content of the inorganic filler may be in a range of 15-50 wt %, or, more specifically, in a range of 20-40 wt % with respect to the total weight of the polymer-based material. The inorganic filler may include one selected from the group comprising or consisting of glass fiber, carbon fiber, silica, calcium carbonate, talc, wollastonite, mica, or any combinations thereof. In one example, the inorganic filler may be in the form of fiber.

When the inorganic filler is in the form of fiber, the inorganic filler may have an average diameter in a range of 8-15 micrometers (μm) and an average length in a range of 2.5-5.0 mm.

Since the inorganic filler has this content and the fiber form, it may contribute to meeting the properties required for the cooling pipes of the drive motor and may minimize a reduction in bonding strength.

The polymer-based materials may include polyamide 6 and glass fiber, and PA6-GF30 manufactured by BASF Corporation may be applied.

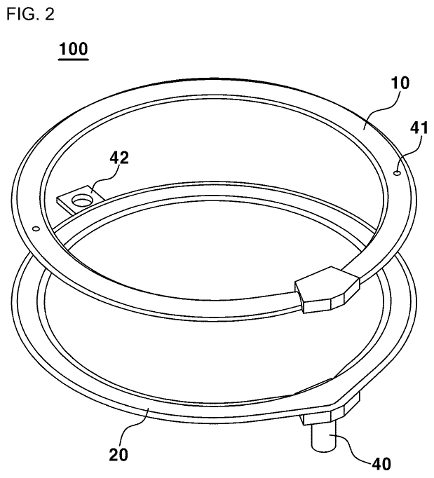

Referring to FIG. 2, a part of the circulation pipe structure 100 may further include an inlet 40 that communicates with the pipe inner space 15. Another part of the circulation pipe structure 100 may further include an injection hole that communicates with the pipe inner space 15. Optionally, yet another part of the circulation pipe structure 100 may further include a mounting part 42.

An embodiment manufactured in the Example described below may have a form in which the injection hole 41 is omitted for a burst pressure test.

The circulation pipe structure 100 may be applied as a pipe for cooling a drive motor of an electric vehicle, as shown in FIG. 1. Additionally, cooling oil, such as automatic transmission fluid (ATF) or the like, may flow into the pipe inner space 15.

The circulation pipe structure 100 may have advantages, such as cost reduction and weight reduction, compared to circulation pipes formed of a metal, such as stainless steel. The circulation pipe structure 100 may also advantageously secure an insulation distance from the drive motor, and may provide more freedom in design in the layout of parts.

The circulation pipe structure 100 may have a simplified manufacturing process, a low burr content, and high dimensional stability compared to a polymer circulation pipe manufactured by simple extrusion molding and pipe forming.

The circulation pipe structure 100 may have a low possibility of deformation even when high-temperature fluid flows thereinto. The circulation pipe structure 100 may also minimize problems, such as deformation or change in the positions of an inlet or an injection hole compared to the polymer circulation pipe in which arbitrary members are combined by ultrasonic treatment.

### Manufacturing Method of a Circulation Pipe Structure

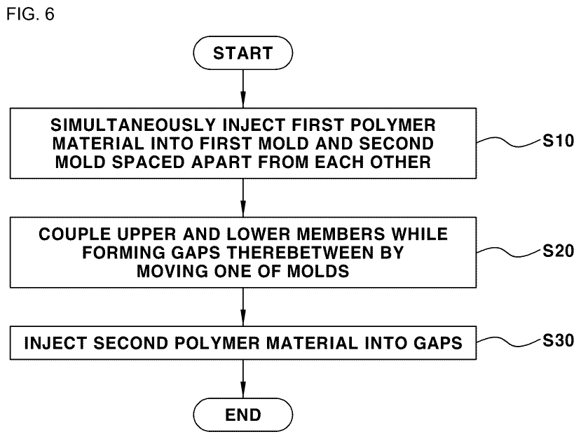

Referring to FIGS. 5 and 6, the manufacturing method of the circulation pipe structure 100 according to one embodiment of the present disclosure may include (a) simultaneously primarily injecting a first polymer material into a first mold having the shape of the upper member 10 and a second mold having the shape of the lower member 20 (S10). The method may also include (b) engaging the upper member 10 and the lower member 20 with each other while forming gaps therebetween by moving one of the first mold and the second mold (S20). The method may also include (c) secondarily injecting a second polymer material into the gaps (S30). In step (a) (S10), the first mold and the second mold may be spaced apart from each other. In step (c) (S30), the temperature of the upper member 10 and the lower member 20 may be 140° C. or higher and the injection temperature of the second polymer material may be 300° C. or higher.

The first polymer material in step (a) (S10) and the second polymer material in step (c) (S30) may be substantially the same as the above-described polymer-based materials.

When injecting the first polymer material in step (a) (S10), an injection port through which the first polymer material is injected into the first mold and the second mold may communicate with the spaces in the first mold and the second mold in a molding machine as shown in FIG. 5.

The injection temperature of the first polymer material in step (a) (S10) may be equal to or higher than the melting point of the first polymer material, and may be in a range of 270-320° C.

Step (b) (S20) may include: opening the first mold and the second mold in which step (a) (S10) was performed; moving one of the first mold and the second mold so that the first member and the second member are in the same phase (e.g., orientation); and coupling the upper member 10 and the lower member 20 in the first mold and the second mold to each other so as to form the circulation pipe structure 100 through engagement therebetween.

The injection temperature of the second polymer material in step (c) (S30) may be higher than the injection temperature of the first polymer material in step (a) (S10), and may be, for example, in a range of 300-330° C.

When injecting the second polymer in step (c) (S30), the temperature of the upper member 10 and the lower member 20 coupled to each other in step (b) (S20) may be in a range of 140-180° C.

When injecting the second polymer in step (c) (S30), the temperature of the first mold and the second mold may be in a range of 120-180° C.

By performing step (a) (S10) and step (c) (S20) at the above injection temperatures, an excellent bonding force among the upper member 10, the lower member 20, and the coupling members 35 and 35′ may be achieved. Additionally, desired properties for cooling pipes for drive motors may be secured.

Hereinafter, the present disclosure is described in more detail through the following Example and Comparative Examples. The following Example and Comparative Examples serve merely to describe the present disclosure and are not intended to limit the scope and spirit of the present disclosure.

### Example—Manufacture of an Annular Pipe Structure Through Die Slide Injection (DSI)

For step (a), PA6-GF30 (polyamide 6 including 30 wt % of glass fiber) manufactured by BASF was primarily injected simultaneously into a first mold having the shape of an upper member 10 and a second mold having the shape of a lower member 20 at a temperature of 300° C., as shown in FIG. 5.

For step (b), the first mold and the second mold were opened, and the first mold was moved so that the upper and lower members 10 and 20 were in the same phase, ensuring that the internal spaces of the first member 19 and the second member 20 formed in the respective molds were symmetrical to each other. Subsequently, the upper member 10 and the lower member 20 in the first mold and the second mold were coupled to be engaged with each other so as to form the pipe inner space 15 and the gap 31 provided from the outermost thickness region of an annular pipe structure to the pipe inner space 15. The temperature of the respective molds was maintained at 150° C., and the temperature of the first and second members 10 and 20 in the molds was maintained at 150° C.

For step (c), PA6-GF30 manufactured by BASF was secondarily injected into the gaps 31 and 31′ at a temperature of 30° C. After cooling and opening the molds, the annular pipe structure was taken out. The annular pipe structure included an inlet 40 at some parts and a mounting part 42 at opposite parts farthest from these parts.

The manufactured annular pipe structure was tested by varying specific conditions as follows.

### Test Examples—Dimensional Inspection, Burst Pressure Test, Vibration Durability Test, Joint Analysis Depending on Injection Conditions, and CT Inspection Analysis

### 1) Dimensional Inspection

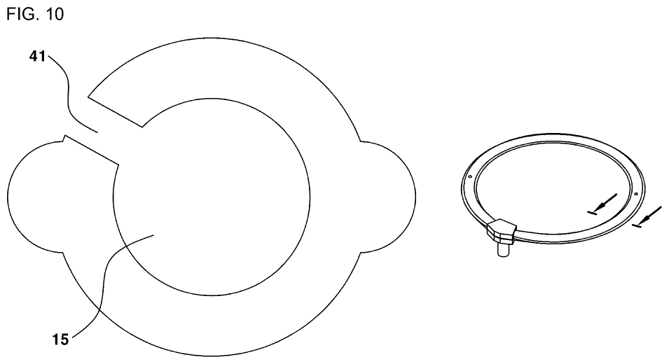

The annular pipe structure manufactured in Example was photographed, and the obtained photograph of the annular pipe structure is shown in FIG. 10. It was confirmed that, compared to an annular pipe formed of stainless steel, the annular pipe structure manufactured in Example satisfied dimensions and tolerance at the same level as the annular pipe formed of stainless steel.

### 2) Burst Pressure Test

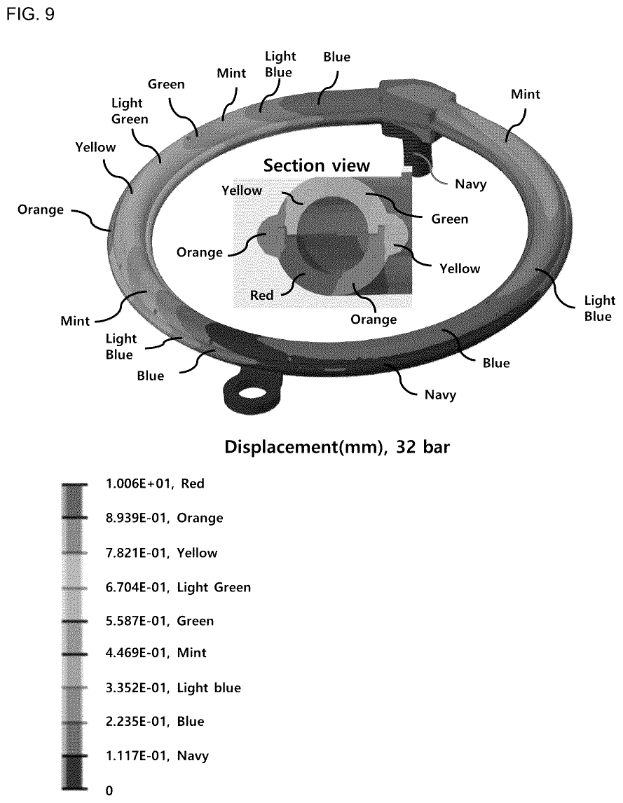

Pressure was gradually raised while supplying automatic transmission fluid (ATF) to the inlet of the annular pipe structure manufactured in the Example based on a stress-strain diagram at a temperature of 120° C. A pressure at breakage of the annular pipe structure was measured, and the degrees of deformation of respective parts of the annular pipe structure are shown in FIG. 9. As a result of the measurement, the pressure at breakage of the annular pipe structure was 32 bar and the average amount of deformation at this time was about 1 mm. It was confirmed that, considering that the actual pressure applied to a cooling circulation pipe is around 3 bar, there is very little risk of damage to the annular pipe structure due to internal pressure.

### 3) Vibration Durability Test

The maximum stresses generated at the mounting part and the coupling part of the annular pipe structure manufactured in the Example were measured through a uniaxial vibration tester under conditions of 98.2 Hz and 3.8×105 cycles, 205.9 Hz and 1.7×106 cycles, and 205.9 Hz, 120° C., and 107 cycles. The results of the measurement are set forth in Table 1 below.

TABLE 1

| | Mount- | Cou- | Mount- | Cou- | Mount- | Cou- |
|---|---|---|---|---|---|---|
| | ing | pling | ing | pling | ing | pling |
| | part | member | part | member | part | member |
| Category | (x-axis) | (x-axis) | (y-axis) | (y-axis) | (z-axis) | (z-axis) |
| 98.2 Hz | 11.17 | 2.13 | | | | |
| 205.9 Hz | | | 1.34 | 0.16 | 11.96 | 1.36 |
| 205.9 Hz | 16 | 9.8 | 16 | 9.8 | 16 | 9.8 |
| 120° C. | | | | | | |

Unit: MPa
The x-axis: Direction perpendicular to the direction from the mounting part to the coupling member.
The y-axis: Direction from the mounting part to the coupling member.
The z-axis: Direction perpendicular to the x-axis and the y-axis.

Referring to Table 1, it was confirmed that stress below breaking strength was generated at the mounting part and the coupling part.

### 4) Injection Joint Analysis Depending on Injection Process Conditions

During the secondary injection in step (c), remolding rates near the secondary injection molded product depending on the injection temperature, the mold temperature, and the temperature of the primary injection molded products (the upper member and the lower member) were measured through Moldex 3D, which is plastic injection molding simulation software. The results of the measurement are set forth in Table 4 below. When the remelting rate was less than 2%, it was determined as being unsuitable.
4-1) Injection joint analysis depending on mold temperature—with primary injection molded products at 150° C. and secondary injection molded products at 320° C.

TABLE 2

| Mold | | | | | | |
|---|---|---|---|---|---|---|
| temperature | 120° C. | 130° C. | 140° C. | 150° C. | 160° C. | 170° C. |
| Remelting | 2.109 | 2.11 | 2.113 | 2.128 | 2.319 | 2.375 |
| rate | | | | | | |
| (%) | | | | | | |

4-2) Injection joint analysis depending on the temperature of primary injection molded products—with a mold temperature of 120° C. and a temperature of secondary injection molded products at 320° C.

TABLE 3

| | Temperature of primary injection molded products | | | | |
|---|---|---|---|---|---|
| | 130° C. | 140° C. | 150° C. | 160° C. | 170° C. |
| Remelting | 1.206 | 2.075 | 2.128 | 2.73 | 3.76 |
| rate (%) | | | | | |

TABLE 4

| | Temperature of secondary injection molded product | | | | |
|---|---|---|---|---|---|
| | 280°C | 290°C | 300° C. | 310° C. | 320° C. |
| Remelting | 1.166 | 1.853 | 2.093 | 2.108 | 2.128 |
| rate (%) | | | | | |

Referring to Tables 2-4, it was confirmed that, when the temperature of the primary injection molded products is 130° C. or lower and when the temperature of the secondary injection molded product is 290° C. or lower, the remelting rate is less than 2%. As a result, the bonding strength may not be secured and fusion may not be sufficiently achieved. Additionally, in other cases, sufficient bonding strength may be secured and fusion of the coupling member to the gap is good.

### 5) Computed Tomography (CT) Examination Analysis

The cross-section of the annular pipe structure manufactured in Example was photographed using a CT scanner, and the obtained photograph is shown in FIGS. 10 and 11.

FIG. 10 shows the cross-section of a part of the circulation pipe structure where the injection hole 41 is located. FIG. 11 shows the cross-section of a part of the circulation pipe structure where no injection hole is located. It was confirmed that no by-products (burrs) were generated near the injection hole 41 and that the embossed and engraved parts and the coupling member 35 were effectively fused within the gap of the coupling part.

As is apparent from the above description, a circulation pipe structure according to the present disclosure includes a polymer-based material and fuses a coupling member to a part of a coupling part. As a result, the circulation pipe structure is capable of having high economic efficiency, formability, and design freedom. Additionally, the circulation pipe structure achieves a low possibility of post-change, achieves weight reduction, and secures properties desired for cooling pipes of driving motors.

The effects of the present disclosure are not limited to the above-mentioned effects. The effects of the present disclosure should be understood to include all effects that may be inferred from the above description.

The present disclosure has been described in detail with reference to various embodiments thereof. However, it should be appreciated by those having ordinary skills in the art that changes may be made in these embodiments without departing from the principles and spirit of the present disclosure, the scope of which is defined in the appended claims and their equivalents.

What is claimed is:

1. A circulation pipe structure comprising:
an upper member;
a lower member coupled to the upper member to form the circulation pipe structure;
first coupling parts respectively provided on the upper member and the lower member and engaged with each other when the upper member and the lower member are coupled; and
a second coupling part that couples the upper member and the lower member to each other by a coupling member.

2. The circulation pipe structure of claim 1, wherein the coupling member is fused to a gap between the upper member and the lower member.

3. The circulation pipe structure of claim 1, wherein the upper member, the lower member, and the coupling member are molded and combined by applying die slide injection.

4. The circulation pipe structure of claim 2, wherein the gap is disconnected from a pipe inner space.

5. The circulation pipe structure of claim 1, wherein the second coupling part protrudes outward from the upper member and the lower member.

6. The circulation pipe structure of claim 1, wherein the first coupling parts comprise structures engaged with each other by an engraved-embossed part provided in and on the upper member and the lower member, respectively, inside the coupling member.

7. The circulation pipe structure of claim 1, wherein a circulation shape of the circulation pipe structure comprises a circle, an oval, a polygon, a single closed curve, or any combination thereof.

8. The circulation pipe structure of claim 1, wherein an average thickness of the circulation pipe structure, other than the first coupling parts and the second coupling part, is in a range of 1-6 millimeters (mm), based on a pipe inner space and an outside of the circulation pipe structure.

9. The circulation pipe structure of claim 2, wherein a thickness of the gap is in a range of 0.3-2.5 mm.

10. The circulation pipe structure of claim 1, comprising a polymer-based material including a polyamide-based resin, polycarbonate-based resin, a polystyrene-based resin, or any combination thereof,
wherein the polymer-based material further includes an inorganic filler.

11. The circulation pipe structure of claim 10, wherein:
a content of the inorganic filler is in a range of 15-50 wt % with respect to a total weight of the polymer-based material; and
the inorganic filler comprises glass fiber, carbon fiber, silica, calcium carbonate, talc, wollastonite, mica, or any combination thereof.

12. The circulation pipe structure of claim 11, wherein the polymer-based material comprises polyamide 6 and glass fiber.

13. The circulation pipe structure of claim 12, wherein the glass fiber has an average diameter in a range of 8-15 micrometers (μm) and an average length in a range of 2.5-5.0 mm.

14. The circulation pipe structure of claim 1, wherein a part of the circulation pipe structure further comprises an inlet that communicates with a pipe inner space.

15. The circulation pipe structure of claim 1, wherein a part of the circulation pipe structure further comprises at least one injection hole that communicates with a pipe inner space.

16. The circulation pipe structure of claim 1, wherein:
the first coupling parts and the second coupling part are formed in a part or an entirety of an outer thickness region of the circulation pipe structure;
the circulation pipe structure further comprises third coupling parts and a fourth coupling part formed in a part or an entirety of an inner thickness region of the circulation pipe structure;
the third coupling parts are respectively provided on the upper member and the lower member and engaged with each other when the upper member and the lower member are coupled; and
the fourth part couples the upper member and the lower member to each other by an additional coupling member.

17. A manufacturing method of a circulation pipe structure, the manufacturing method comprising:
primarily injecting a first polymer material simultaneously into a first mold having a shape of an upper member and a second mold having a shape of a lower member;
engaging the upper member and the lower member with each other while forming gaps therebetween by moving one of the first mold and the second mold; and
secondarily injecting a second polymer material into the gaps,
wherein
in primarily injecting the first polymer material, the first mold and the second mold are spaced apart from each other; and
in secondarily injecting the second polymer material, a temperature of the upper member and the lower member is 140° C. or higher, and an injection temperature of the second polymer material is 300° C. or higher.

18. The manufacturing method of claim 17, wherein engaging the upper member and the lower member with each other comprises:
opening the first mold and the second mold after simultaneously injecting the first polymer material into the first mold and the second mold;
moving one of the first mold and the second mold so that the upper member and the lower member are in the same phase; and
coupling the upper member and the lower member in the first mold and the second mold to each other so as to form the circulation pipe structure through engagement therebetween.

19. The manufacturing method of claim 17, wherein the injection temperature of the second polymer material, in secondarily injecting the second polymer material, is higher than an injection temperature of the first polymer material, in primarily injecting the first polymer material.
